(19) United States
(12) Patent Application Publication
(10) Pub. No.: US 2005/0121834 A1
(43) Pub. Date: Jun. 9, 2005

(54) Method and apparatus for bending resin tube

(76) Inventors: Kazuhiro Ezure, Koga-shi (JP); Norio Kobayashi, Koga-shi (JP); Morito Somemiya, Koga-shi (JP)

Correspondence Address: VARNDELL & VARNDELL, PLLC, 106-A S. COLUMBUS ST., ALEXANDRIA, VA, 22314, US

(21) Appl. No.: 10/981,700

(22) Filed: Nov. 5, 2004

(30) Foreign Application Priority Data
Dec. 4, 2003 (JP) 2003-405300

(51) Int. Cl. B29C 53/08; B29C 53/84

(52) U.S. Cl. 264/449; 425/392; 425/384; 425/174; 264/339; 264/322

(57) ABSTRACT

There is provided a method for bending a resin tube that enables resin tubes having a variety of bend configurations to be worked simply and rapidly without fabrication of a plurality of bending dies. In the method for bending a resin tube, a resin tube is bent to a desired angle with a bending apparatus, heated by high-frequency dielectric heating while the bent state of the resin tube is maintained by the bending apparatus, cooled, and released from being held by the bending apparatus.

### BACKGROUND OF THE INVENTION

1. Field of the Invention

The present invention relates to a method and apparatus for bending a resin tube, and more particularly to a method and apparatus for bending a resin tube in which a resin tube bent into a variety of configurations can be simply and rapidly worked without fabrication of a plurality of bending dies.

2. Description of the Related Art

Resin tubes need to be bent in advance when used as piping or the like in automotive vehicles in order to prevent interference with other components.

Conventional methods for bending resin tubes involve working a resin tube by positioning the tube in a bending die formed from a metal having good thermal conductivity; immersing the tube together with the bending die in a polyethylene glycol bath or other high-temperature tank, spraying high-temperature steam, hot air, or the like through the interior of a resin tube positioned in the bending die, or using another method to heat and soften the resin tube; removing the stress generated as a result of having bent the tube; forming the resin tube into a configuration that conforms to the bending die; and then cooling the tube.

In Japanese Patent Application Laid-open No. 9-029831, a method is disclosed for heating resin rubes using high-frequency dielectric heating, in consideration of the wastewater pollution that has occurred in recent years when high-temperature tanks containing polyethylene glycol baths or the like are employed, and of the poor thermal efficiency and prolonged operating times encountered in heating methods wherein high-temperature steam, hot air, or the like is employed.

In the method disclosed in Japanese Patent Application Laid-open No. 9-029831, and as shown in FIG. 13, a bending die 51 is fabricated from an electrically conductive material; a resin tube A with an inserted core rod 53 that has been formed from an electrically conductive material in the same manner is positioned in a groove 52 formed in the bending die 51; a high-frequency voltage is applied between the bending die 51 and the core rod 53 to dielectrically heat the resin tube A; the electrical power is then switched off; and the tube is cooled.

### SUMMARY OF THE INVENTION

Nevertheless, when an attempt is made to obtain resin tubes of different bend configurations with the methods described in the foregoing, bending dies that conform to these bend configurations must be fabricated. There is a dramatic increase in die cost, and it becomes difficult to automate procedures for positioning the resin tubes in the bending dies. Therefore, these methods often require human assistance and are of low practicality.

In view of the above, it is an object of the present invention to provide a method and apparatus for bending a resin tube that enables resin tubes having a variety of bend configurations to be simply and rapidly worked without fabrication of a plurality of bending dies.

The aforesaid object is resolved by the present invention as recited in the claims.

In other words, there is provided a method for bending a resin tube wherein a resin tube is bent to a desired angle with a bending apparatus, heated by high-frequency dielectric heating while the bent state of the resin tube is maintained by the bending apparatus, cooled, and released from being held by the bending apparatus.

Also provided is an apparatus for bending a resin tube comprising a bending die; a clamping die for fixing the resin tube in the bending die; and a pressure die for relatively moving the resin tube along the bending die while pressing the tube against the bending die, wherein an electrode plate for applying a high-frequency voltage is disposed in the bending die.

In the method for bending a resin tube as described herein, the preferred embodiments are that the bending portion of the resin tube is further preheated by high-frequency dielectric heating before the resin tube has been bent with the bending apparatus, and that the resin tube is a mono- or multi-layered tube having a thermoplastic resin layer that is readily susceptible to high-frequency dielectric heating.

Also, in the apparatus for bending a resin tube, the preferred embodiments are that an electrode plate for applying a high-frequency voltage is further disposed in the pressure die, that the bending die is provided with, on the peripheral surface thereof, a groove capable of accommodating the entire radial direction of the resin tube, that the clamping die and the pressure die are provided with, on the distal end thereof, grooves capable of accommodating the entire radial direction of the portion of the resin tube that is separated from the groove of the bending die, and that the bending die, clamping die, and pressure die are formed from a material that is not readily susceptible to high-frequency dielectric heating.

In the method for bending a resin tube according to the aforedescribed present invention, a resin tube is bent to a desired angle with a bending apparatus, heated by high-frequency dielectric heating while the bent state of the resin tube is maintained by the bending apparatus, cooled, and released from being held by the bending apparatus. It is accordingly possible to simply and rapidly work resin tubes of any bend configuration by using a bending apparatus without fabricating a plurality of bending dies, in contrast to conventional bending methods wherein bending dies are employed.

Since resin tubes are heated by high-frequency dielectric heating, it is possible to prevent the wastewater pollution that occurs when high-temperature tanks containing polyethylene glycol baths or the like are employed; the reduced thermal efficiency and increased operating times that are encountered in heating methods wherein high-temperature steam, hot air, or the like is employed; and other problems. Heating can be conducted efficiently in a short period of time, and the working time can be reduced. High-frequency dielectric heating also enables only the bending portion to be subjected to what is referred to as partial heating, allowing, for example, connectors to be pointed or the like before they are bent, which is impossible to achieve with the conventional complete heating, and also making it possible to increase the degree of latitude in designing the steps required to work the resin tubes.

The apparatus for bending resin tubes according to the present invention as described in the foregoing is provided with a bending die, a clamping die for fixing the resin tube in the bending die, and a pressure die for relatively moving the resin tube along the bending die while pressing the tube against the bending die, and an electrode plate for applying a high-frequency voltage is disposed in the bending die. Therefore, a resin tube is positioned between the bending die and the clamping die; for example, the clamping die and the bending die are rotated to pull and bend the resin tube; the bent state of the resin tube is then maintained by having both ends of the bent portion of the resin tube sandwiched between the clamping die and the bending die and between the pressure die and the bending die, and a high-frequency voltage is applied to the electrode plate disposed in the bending die in this state, making it possible to heat only the bent portion of the resin tube and thereby remove the stress generated as a result of having bent the resin tube. If the resin tube is released from being held by the clamping die and pressure die following natural or forced cooling, it will be possible to obtain a resin tube having a prescribed bend configuration.

### BRIEF DESCRIPTION OF THE DRAWINGS

FIG. 1 is a plan view schematically showing the manner in which a resin tube is positioned in an embodiment of the bending apparatus according to the present invention;

FIG. 2 is a plan view schematically showing the state of the next step after FIG. 1;

FIG. 3 is a plan view schematically showing the state of the next step after FIG. 2;

FIG. 4 is a plan view schematically showing the state of the next step after FIG. 3;

FIG. 5 is a plan view schematically showing the state of the next step after FIG. 4;

FIG. 6 is a plan view schematically showing the state of the next step after FIG. 5;

FIG. 7 is a plan view schematically showing the state of the next step after FIG. 6;

FIG. 8 is a cross-sectional view of the region along line A-A in FIG. 4;

FIG. 9 is a cross-sectional view of the region along line B-B in FIG. 4;

FIG. 10 is a cross-sectional view of the region along line C-C in FIG. 4;

FIG. 11 is a plan view schematically showing the state of the step of FIG. 2 for another embodiment of the bending apparatus according to the present invention;

FIG. 12 is a cross-sectional view of the region along line D-D in FIG. 11; and

FIG. 13 is a perspective view schematically showing a conventional method for bending a resin tube.

### DESCRIPITON OF THE PREFERRED EMBODIMENTS

Embodiments of the method and apparatus for bending a resin tube according to the present invention as described in the foregoing shall be described in further detail hereunder with reference being made to the drawings.

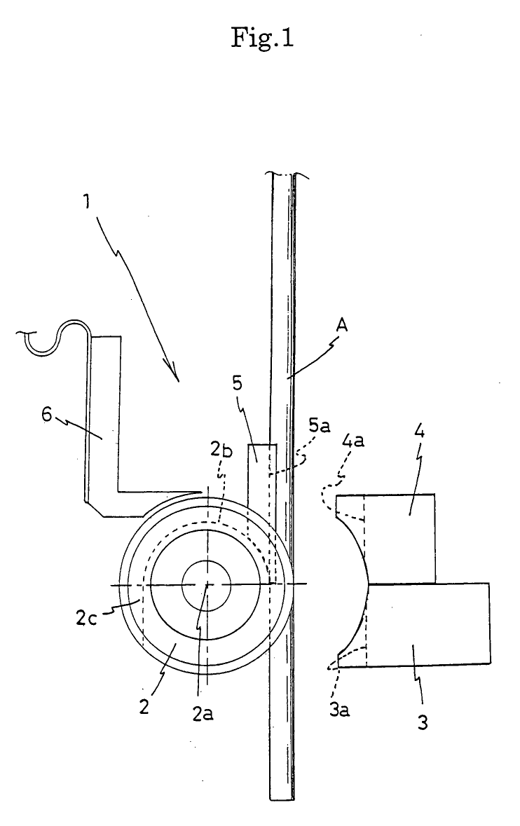

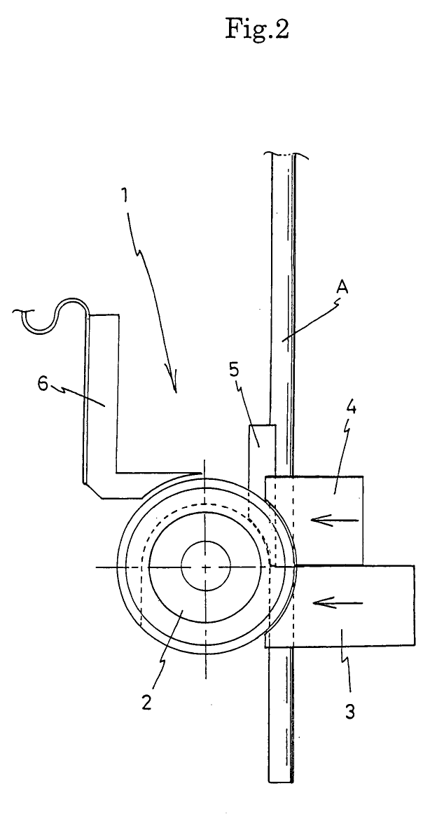

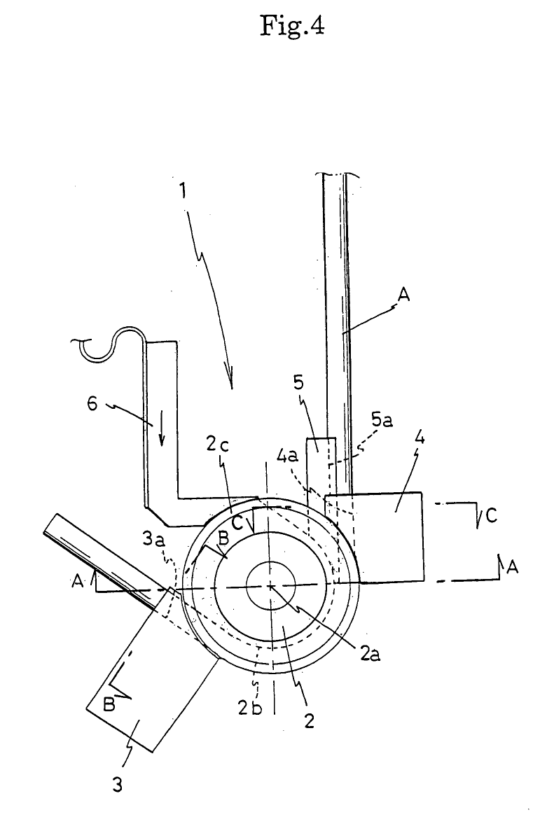

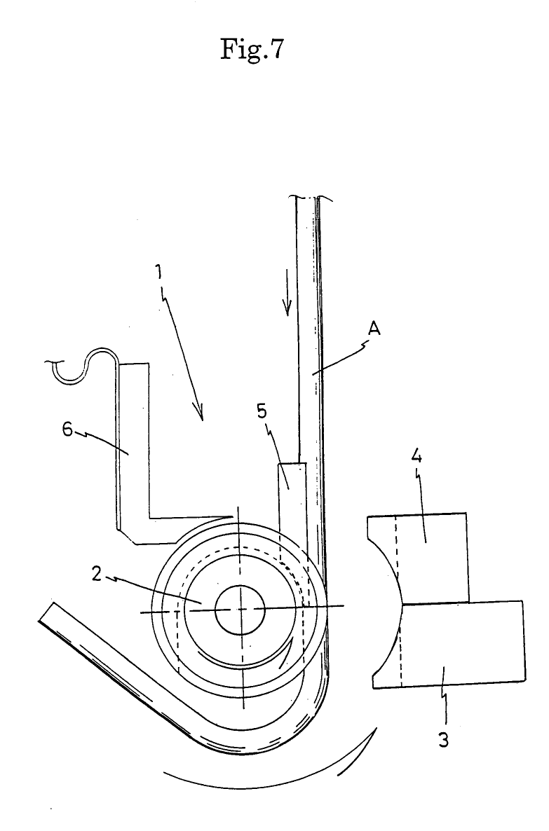

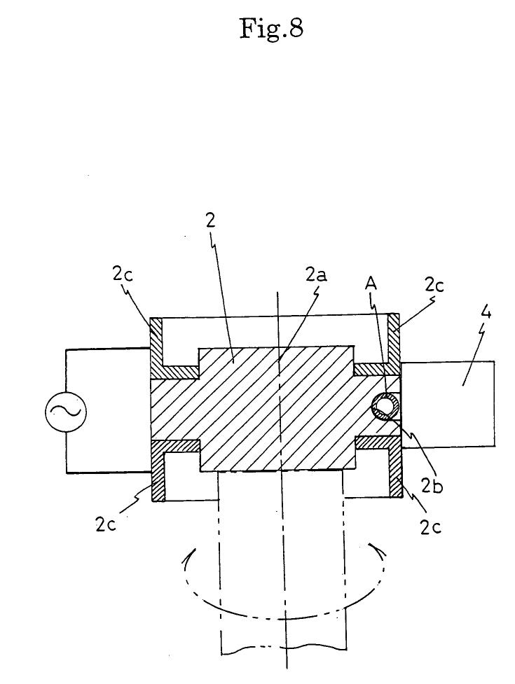

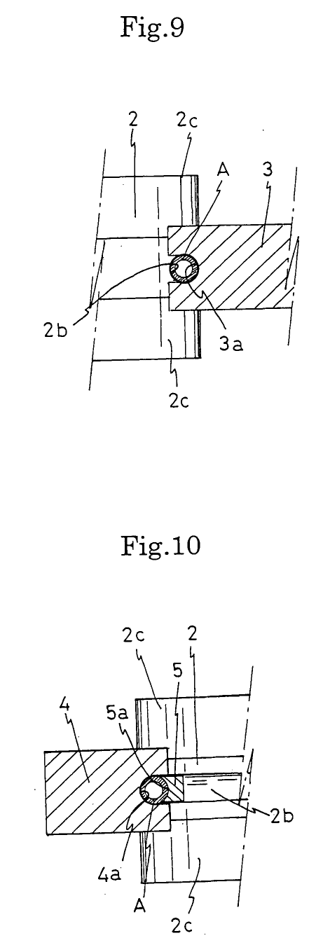

FIG. 1 is a plan view schematically showing an embodiment of the apparatus for bending a resin tube according to the present invention, FIGS. 2 through 7 are plan views showing the actions involved in bending a resin tube with the apparatus shown in FIG. 1, FIG. 8 is a cross-sectional view of the region along line A-A in FIG. 4, FIG. 9 is a cross-sectional view of the region along line B-B in FIG. 4, and FIG. 10 is a cross-sectional view of the region along line C-C in FIG. 4.

The bending apparatus 1 shown in the drawings is equipped with a bending die 2, a clamping die 3 for fixing a resin tube A in the bending die 2, a pressure die 4 for relatively moving the resin tube A along the bending die while pressing the tube against the bending die, a spacer die 5 for filling the gap between the bending die 2 and the resin tube A, and an electrode 6 for applying high-frequency voltage.

The bending die 2 is rotatably disposed on a machine casing (not shown) with an axis 2a as the center thereof, and is provided with, on the peripheral surface thereof, a groove 2b capable of accommodating the resin tube A. The groove 2b is of a depth allowing the entire radial direction of the resin tube A to be completely accommodated, and is formed over a range of 180° along the peripheral surface of the bending die 2. Annular electrode plates 2c, 2c are disposed on the upper and lower surfaces of the bending die 2, as shown in FIG. 8. The electrode 6 for applying high-frequency voltage makes contact with these electrode plates 2c, 2c, whereby a high-frequency current flows across the annular electrode plates 2c, 2c, and the resin tube A accommodated within the groove 2b is dielectrically heated.

The clamping die 3 is disposed on the machine frame (not shown) while allowed to connect to and separate from the bending die 2 and to rotate about the axis 2a together with the bending die 2; and is provided with a groove 3a set opposite the groove 2b on the bending die 2. The groove 3a formed on the distal end of the clamping die 3 and, as shown in FIG. 9, is formed to a depth allowing the entire radial direction of the portion of the resin tube A that is separated from the groove 2b of the bending die 2 to be completely accommodated.

The pressure die 4 is disposed in a detachable fashion relative to the bending die 2 on a machine casing (not shown), and relatively moves the resin tube A along the bending die 2 according to the rotating of the bending die 2 while pressing the tube on the bending die 2. The distal end of the pressure die 4 is provided with a groove 4a set opposite to the groove 2b on the bending die 2, and, as shown in FIG. 10, is formed to a depth allowing the entire radial direction of the portion of the resin tube A that is separated from the groove 2b of the bending die 2 to be completely accommodated.

The spacer die 5 is disposed facing the pressure die 4 on a machine casing (not shown), the portion of the resin tube A that is separated from the groove 2b of the bending die 2 is sandwiched thereby, and the gap between the bending die 2 and the resin tube A is filled. The surface of the spacer die 5 that faces the pressure die 4 is provided with a groove 5a that accommodates the resin tube A, as shown in FIG. 10.

The bending die 2, clamping die 3, pressure die 4, and spacer die 5 are formed from a fluororesin, polypropylene, polyethylene, or another material that is not readily susceptible to high-frequency dielectric heating.

The resin tube A is bent with the aforedescribed bending apparatus 1 in the manner described hereunder.

The resin tube A to be bent is a mono- or multi-layered tube having a thermoplastic resin layer that is readily susceptible to high-frequency dielectric heating; e.g., the resin tube A has at least one resin layer formed from a polyamide, polyketone, polyoxymethylene, polyester, or the like.

As shown in FIG. 1, first, the resin tube A is positioned in the bending apparatus 1. Next, as shown in FIG. 2, the clamping die 3 and pressure die 4 are moved towards the bending die 2, the resin tube A is sandwiched between the clamping die 3 and the bending die 2, and the resin tube A is pressed on the bending die 2 by the pressure die 4.

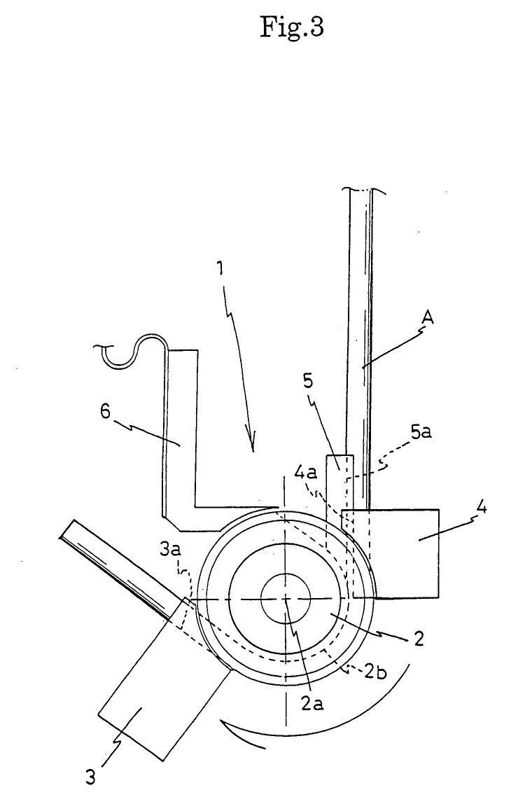

In this state, the clamping die 3 is caused to rotate together with the bending die 2 about the axis 2a, as shown in FIG. 3, and the resin tube A is pulled and bent to the desired angle. During this action, the pressure die 4 moves the resin tube A along the bending die 2 by the rotation of the bending die 2 while pressing the tube on the bending die 2, and prevents the resin tube A from separating from the bending die 2.

Once the resin tube A has been bent as described in the foregoing, the bent state of the resin tube A is maintained by having both ends of the bending portion of the resin tube A sandwiched between the clamping die 3 and the bending die 2, and between the pressure die 4 and the bending die 2. In this state, the electrode 6 for applying high-frequency voltage is brought into contact with the annular electrode plates 2c, 2c disposed on upper and lower surfaces of the bending die 2, as shown in FIG. 4, and high-frequency current is passed between the annular electrode plates 2c, 2c. The frequency of the current thus passed is commonly 3 to 100 MHz, and preferably 10 to 50 MHz.

When high-frequency current flows between the annular electrode plates 2c, 2c, the resin tube A accommodated in the groove 2b situated between the annular electrode plates 2c, 2c, as shown in FIG. 8, will undergo high-frequency dielectric heating, heat will be evolved inside the resin tube A, and the tube will soften. The stresses generated as a result of the bending will accordingly be removed.

During this action, the entire radial direction of the resin tube A will be completely accommodated in the groove 2b provided to the bending die 2, as shown in FIG. 8, and the portion of the resin tube A that is separated from the groove 2b of the bending die 2 will be covered by grooves 3a, 4a, 5a respectively provided to the clamping die 3, pressure die 4, and spacer die 5, as shown in FIGS. 9 and 10. As a result, the resin tube A will be heated in a nearly uniform manner by high-frequency dielectric heating.

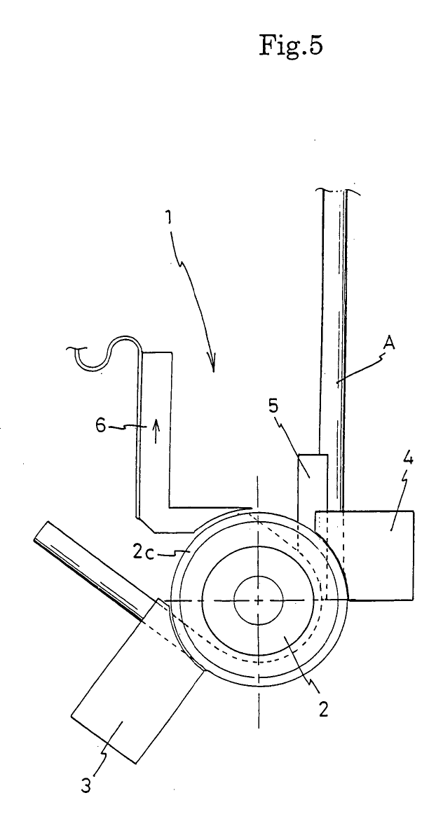

Once the high-frequency voltage has been applied across the annular electrode plates 2c, 2c for a prescribed period of time (several seconds to several tens of seconds), the electrode 6 is detached from the annular electrode plates 2c, 2c, and the heated resin tube A is cooled, as shown in FIG. 5. The resin tube A may be cooled by air-cooling, water-cooling, or another forced cooling method; or by being left alone to cool in an unassisted manner.

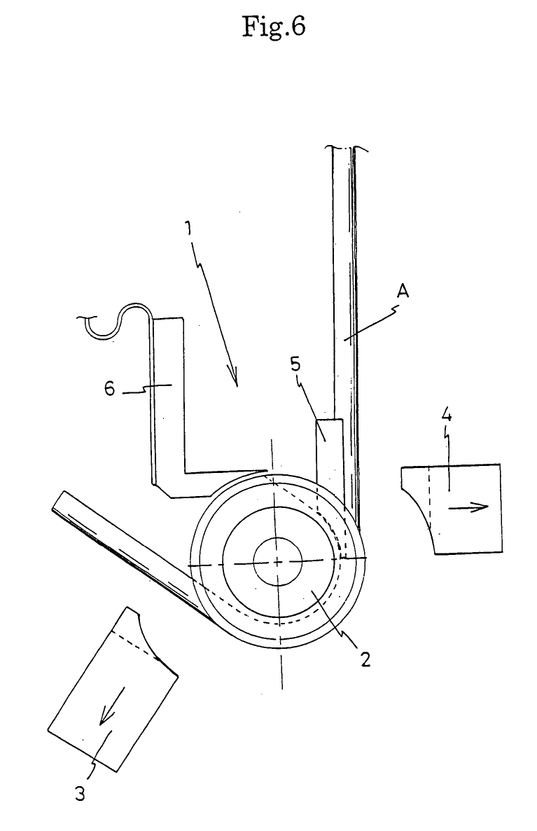

Once the resin tube A has been cooled, the clamping die 3 and pressure die 4 are detached from the bending die 2, and the hold on the resin tube A is released, as shown in FIG. 6.

The resin tube A is heat-molded to the desired bending angle and kept in this configuration by the series of actions described above.

The clamping die 3 and the bending die 2 are subsequently returned to their original positions, as shown in FIG. 7, the resin tube A is moved to the next bending position, and the above-described actions are repeated, whereby subsequent bending is performed on the resin tube A.

Depending on the type, diameter, thickness, and bending angle of the resin tube A that is to be bent, the resin tube A may collapse if suddenly bent while in the aforedescribed cold state. In such circumstances, it is preferable for the bending portion of the resin tube A shown in FIG. 3 to be further preheated with high-frequency dielectric heating before the resin tube A is bent.

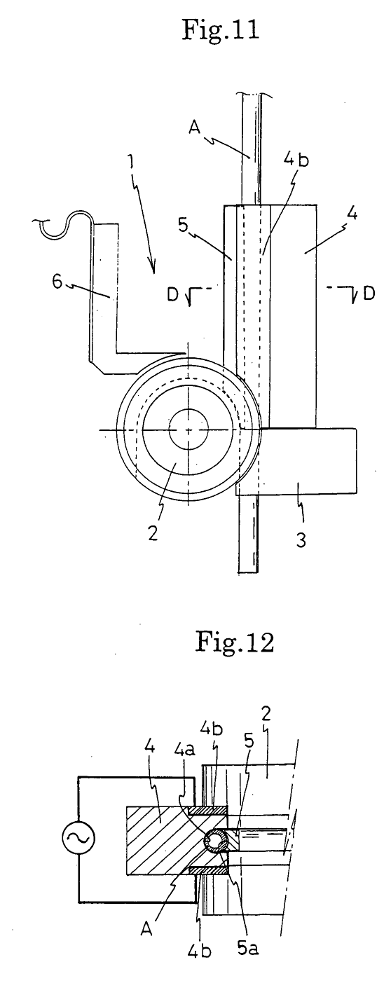

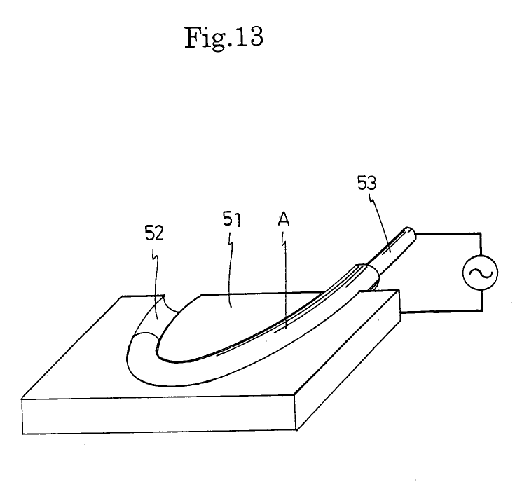

As shown in FIGS. 11 and 12, the apparatus for performing the aforedescribed method may also be configured such that the pressure die 4 and spacer die 5 are extended along the resin tube A; flat electrode plates 4b, 4b for applying a high-frequency voltage are disposed on upper and lower surfaces of the pressure die 4; the high-frequency voltage is applied across the flat electrode plates 4b, 4b in the step before the resin tube A is bent, as shown in FIG. 2; high-frequency current is passed between flat electrode plates 4b, 4b; and high-frequency dielectric heating is induced in the resin tube A in the groove 4a.

Embodiments of the method and apparatus for bending a resin tube according to the present invention have been described hereinabove; however, the present invention shall in no way be construed to be limited to these embodiments, and may embody a variety of modifications and variations within the scope of technical ideas of the invention as recited in the claims.

For example, a description has been provided in the aforedescribed embodiments with regard to a method and apparatus in which the clamping die 3 is rotated together with the bending die 2 about an axis 2a, and the resin tube A is pulled and bent to the desired angle. However, it is also possible to use a method and apparatus in which the pressure die 4 is made to move over the periphery of the bending die 2, and the resin tube A is pushed and bent to the desired angle by the pressure die 4.

Moreover, in the aforedescribed embodiment, the electrode 6 for applying high-frequency voltage is of a movable type and is constituted so that contact is made only when a high-frequency voltage is intended to be applied to the annular electrode plates 2c, 2c; however, in an alternative configuration, the electrode 6 is a brush electrode that remains in constant contact with the electrode plates 2c, 2c. In consideration of the wear generated from the sliding contact of the electrode 6, a movable electrode 6 is preferably used, as in the aforedescribed embodiments.

The aforedescribed embodiments have been described with regard to an apparatus in which a spacer die 5 is used to fill the gap between the bending die 2 and the resin tube A. Although the spacer die 5 is not strictly necessary, if consideration is given to using high-frequency dielectric heating to uniformly heat the resin tube A, the surface of the portion of the resin tube A through which the high-frequency current flows is preferably covered in a uniform fashion. It is accordingly preferable for a spacer die 5 that fills the gap between the bending die 2 and the resin tube A to be present.

1. A method for bending a resin tube, comprising the steps of:
bending a resin tube to a desired angle with a bending apparatus, and heating the resin tube by high-frequency dielectric heating while maintaining the bent state of the resin tube by the bending apparatus; and
releasing the holding of the resin tube by the bending apparatus after cooling the resin tube.

2. The method for bending a resin tube according to claim 1, further comprising a step of preheating the bending portion of the resin tube by high-frequency dielectric heating before the step of bending the resin tube with the bending apparatus.

3. The method for bending a resin tube according to claim 1, wherein the resin tube is a mono- or multi-layered tube having a thermoplastic resin layer that is readily susceptible to high-frequency dielectric heating.

4. An apparatus for bending a resin tube, comprising:
a bending die;
a clamping die for fixing the resin tube in the bending die; and
a pressure die for relatively moving the resin tube along the bending die while pressing the tube against the bending die,
wherein an electrode plate for applying a high-frequency voltage is disposed in the bending die.

5. The apparatus for bending a resin tube according to claim 4, wherein an electrode plate for applying a high-frequency voltage is further disposed in the pressure die.

6. The apparatus for bending a resin tube according to claim 4, wherein the bending die is provided with, on the peripheral surface thereof, a groove capable of accommodating the entire radial direction of the resin tube.

7. The apparatus for bending a resin tube according to claim 6, wherein the clamping die and the pressure die are provided with, on the distal end thereof, grooves capable of accommodating the entire radial direction of the portion of the resin tube that is separated from the groove of the bending die.

8. The apparatus for bending a resin tube according to claim 4, wherein the bending die, clamping die, and pressure die are formed from a material that is not readily susceptible to high-frequency dielectric heating.
